(19) United States
(12) Patent Application Publication
(10) Pub. No.: US 2008/0054503 A1
(43) Pub. Date: Mar. 6, 2008

(54) Retrofittable furnace humidifier system

(76) Inventor: William Patrick, Chesterfield, MO (US)

Correspondence Address: HARNESS, DICKEY & PIERCE, P.L.C., P.O. BOX 828, BLOOMFIELD HILLS, MI, 48303, US

(21) Appl. No.: 11/512,543

(22) Filed: Aug. 30, 2006

(51) Int. Cl. B01F 3/04

(52) U.S. Cl. 261/106; 261/DIG. 15; 261/DIG. 46

(57) ABSTRACT

A retrofittable furnace humidifier system is provided. In various forms of the present disclosure, the system includes a chassis structure sizable to be cooperative an air filter receptacle located between a furnace box and an air supply duct. The system additionally includes a water retention panel mounted to the chassis structure. Water flows through and is retained by the retention panel. The water is absorbed by air flowing through the water retention panel into the furnace box, thereby humidifying and filtering the air. The system further includes a water supply and drain system that forms at least a portion of the chassis structure. The supply and drain provides water to and channels water away from the water retention panel.

### FIELD

The present disclosure relates generally to furnace humidifiers and more particularly to humidifiers for use with existing structures of furnace systems.

### BACKGROUND

The statements in this section merely provide background information related to the present disclosure and may not constitute prior art.

Generally, residential furnace systems utilize electric or gas energy to provide heat for heating cool air drawn into the furnace. The heated air is then forced through air ducts to various locations of the residence to heat the environment within the residence. This heating process causes much of the moisture in the cool air taken into the furnace to evaporate, causing the resulting warm air supplied to the various locations of the residence to become extremely dry and lacking in moisture. Dry air has a tendency to cause uncomfortable conditions for persons and/or pets within the residence. For example, the dry air can cause skin to become dry, itchy and chapped, and eyes to become irritated. Additionally, the dry air can irritate allergies and sinuses of the persons and/or pets by increasing the amount of dust within the residence, dry air can cause furniture, picture frames, wood trim, and other items to crack and warp. As air density increases with high air moisture levels the surrounding environment feels warmer and is more comfortable to persons and/or pets within the residence.

Humidifiers are frequently utilized to correct the dry air problem created by contemporary furnace systems. Known humidifiers consist of bulky, cumbersome, non-aesthetically pleasing stand-alone units placed on the floor of a room that inject moisture into the air using steam or a mist or evaporation. Such stand-alone units do improve the moisture concentration, but are typically only suitable for maintaining a comfortable environment in a single room or a limited volume or space. An alternative to the cumbersome stand-alone humidifiers are furnace-mounted humidifying units. These units are generally expensive and require that one or more holes be cut into the duct work coming off the furnace and installation of a tap from a water line. Additionally, the furnace-mounted humidifiers require electrical power to operate such that an electrical power source must either exist or be installed near the furnace mounted humidifier. Accordingly, installation of a furnace mounted humidifier typically requires a heating and cooling professional to install. Thus, installation of a furnace mounted humidifier is labor intensive, and expensive.

### SUMMARY

The present disclosure provides a retrofittable furnace humidifier system. In various embodiments, the retrofittable furnace humidifier includes a water retention panel mounted to a chassis structure, the chassis structure being sizable to fit within a pre-existing air filter receptacle of a furnace system.

In various other embodiments, the retrofittable furnace humidifier system includes a chassis structure sizable to be cooperative an air filter receptacle located between a furnace box and an air supply duct. The system additionally includes a water retention panel mounted to the chassis structure. Water flows through and is retained by the retention panel. The water is absorbed by air flowing through the water retention panel into the furnace box, thereby humidifying and filtering the air. The system further includes a water supply and drain system that forms at least a portion of the chassis structure. The supply and drain provides water to and channels water away from the water retention panel.

In various other forms the present disclosure provides furnace humidifier system that includes a porous water retention panel mounted to a chassis structure. The porous water retention panel is sized to fit within an air filter receptacle located between a furnace box and an air supply duct. In various embodiments, the chassis structure is constructed to fit substantially flush against a face of the air supply duct and suspend the water retention panel within an opening in the face of the air supply duct. Accordingly, an air filter can be installed within the air filter receptacle unobstructed by the water retention panel and the chassis structure.

In still other implementations, the present disclosure provides a furnace humidifier system that includes a chassis structure comprising a plurality of sizable support members. The support members are sizable such that the chassis structure will fit within any of various air filter receptacles located between a respective furnace box and a respective air supply duct, wherein the various air filter receptacles have various different perimeter dimensions. The system additionally includes a porous water retention panel mounted to the chassis structure and sized to fit within the respective air filter receptacle. The system further includes a water supply and drain system that forms at least a portion of the chassis structure. The supply and drain system for provides water to and channels water away from the water retention panel. In various embodiments, the plurality of support members are constructed to fit substantially flush against a face of the respective air supply duct and suspend the water retention panel within an opening in the face of the respective air supply duct. Accordingly, an air filter can be installed within the respective air filter receptacle unobstructed by the water retention panel and the chassis structure.

Further areas of applicability of the present teachings will become apparent from the description provided herein. It should be understood that the description and specific examples are intended for purposes of illustration only and are not intended to limit the scope of the present teachings.

### BRIEF DESCRIPTION OF THE DRAWINGS

The drawings described herein are for illustration purposes only and are not intended to limit the scope of the present teachings in any way.

FIG. 1 is a perspective view of a furnace system having installed therein a furnace humidifier system in accordance with the principles of the present disclosure;

FIG. 1A is a cross-sectional front view, taken along line A-A of FIG. 2, of the furnace humidifier system constructed in accordance with the principles of the present disclosure;

FIG. 2 is a side view of the furnace system shown in FIG. 1A having a furnace and a forced air duct removed to illustrate a back side of the furnace humidifier system in accordance with the principles of the present disclosure;

FIG. 3 is an enlarged cross-sectional front view, taken along line A-A of FIG. 2, of the furnace humidifier system in accordance with the principles of the present disclosure;

FIG. 4 is an exploded side view of the furnace humidifier system in accordance with the principles of the present disclosure; and

FIG. 5 is a side view of another form of the furnace humidifier, illustrating a chassis structure of the furnace humidifier including a pivot brace, in accordance the principles of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

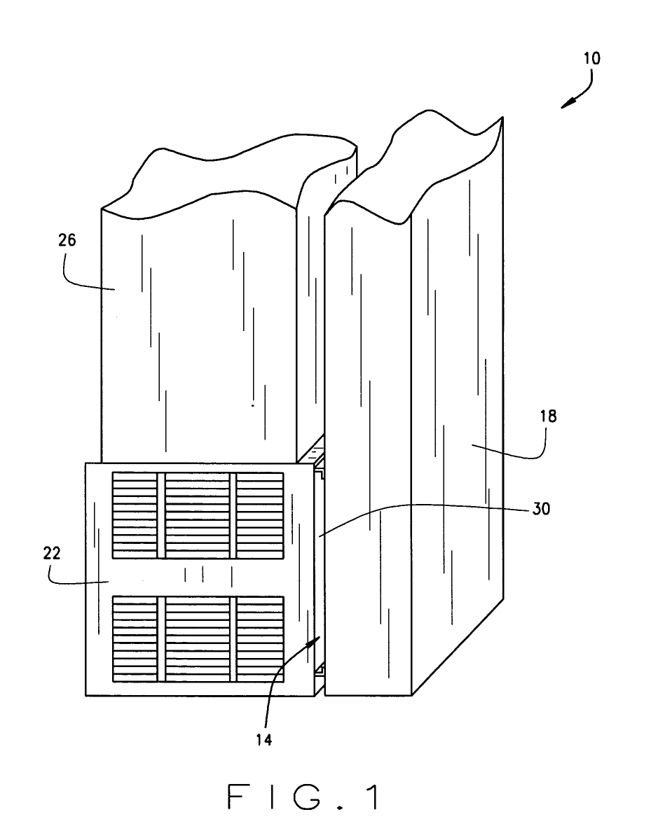

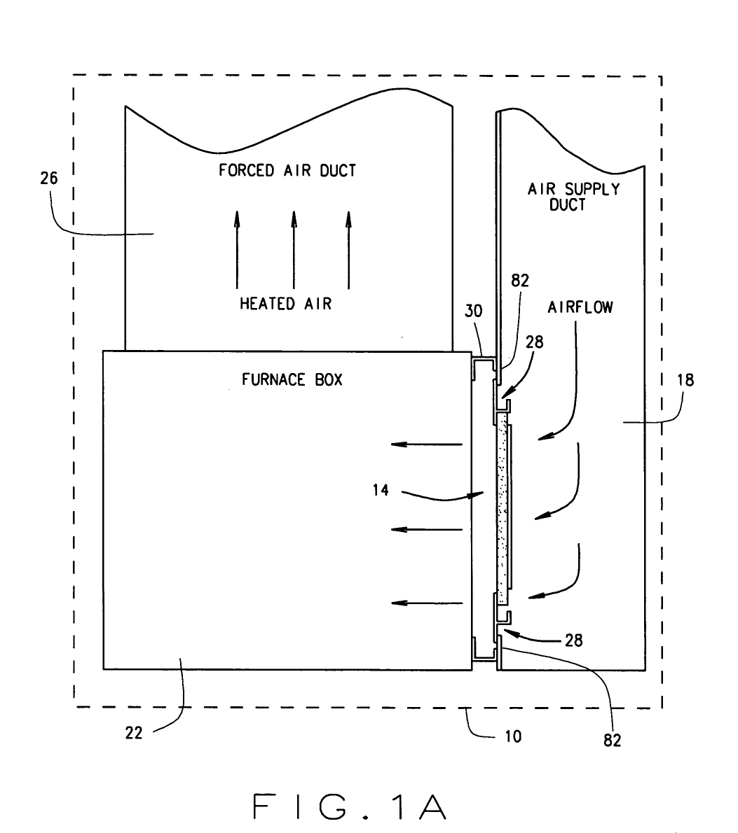

Referring to FIG. 1, a furnace system 10 is provided having installed therein a furnace humidifier system 14 in accordance with the principles of the present disclosure. Generally, the furnace system 10 includes an air supply duct 18, located adjacent a furnace box 22 that heats air provided via the air supply duct 18 and forces the heated air through a forced air duct network 26 to provide heat to selected portions of an enclosed environment (not shown), e.g., a residence or other building. The furnace system 10 additionally includes an air filter receptacle 30 located between the furnace box 22 and the air supply duct 18. The air filter receptacle 30 is structured to receive an air filter (not shown) suited to filter particulate matter from air flowing from the air supply duct 18 into the furnace box 22, such that the forced heated air has a reduced concentration of such particulate matter. As described in detail below, the furnace humidifier system 14 is designed to fit within the air filter receptacle 30 and add moisture to the air flowing into the furnace box 22 from air supply duct 18. Thus, the heated air forced through the forced air duct 26 and provided to the enclosed environment has a desired concentration of moisture.

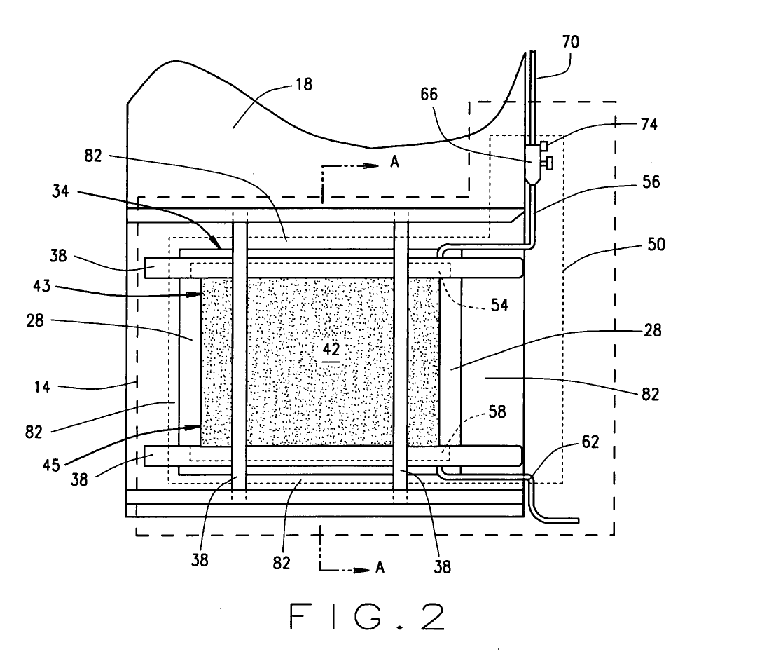

Referring to FIGS. 1A and 2, construction and operation of the furnace humidifier system 14 is now described in greater detail. As best shown in FIG. 2, the air supply duct 18 includes an air passage opening 28 that allows air to flow from the air supply duct 18 into the furnace box 22. Air, from the air supply duct 18, flows through the air passage opening 28 and into the furnace box 22 through the furnace humidifier system 14, which is positioned adjacent or within the air filter receptacle 30. It should be understood that the furnace humidifier 14 can be positioned adjacent the air filter receptacle 30 as shown or positioned within the pre-existing air filter receptacle 30 while remaining within the scope of the present disclosure. Additionally, with furnace systems having multiple air filter receptacles (not shown), the furnace humidifier system 14 can be configured to fit within any of the receptacles along with, or in lieu of, individual filter elements (not shown). Therefore, use of the term “within” shall be construed to include these various configurations in accordance with the teachings of the present disclosure.

As the air flows though the furnace humidifier system 14, the furnace humidifier system 14 adds moisture to the air, as described below, so that the air heated within the furnace box 22 and provided to the enclosed environment has a desired moisture concentration, i.e., humidity. In addition to humidifying the air as the air flows through the furnace humidifier system 14, the furnace humidifier system 14 filters particulate matter from the air to reduce the concentration of particulate matter in the air provided to the enclosed environment.

Referring now to FIGS. 2, 3 and 4, in accordance with various embodiments, the humidifier system 14 includes a chassis structure 34 that includes a plurality of support members 38. The support members 38 are fabricated to be sizable such that the chassis structure 34 will fit within any of various sizes of air filter receptacles 30 located between a respective furnace box 22 and a respective air supply duct 18. Particularly, the various air filter receptacles 30 can have various different horizontal and/or vertical dimensions such that a perimeter of each of the various air filter receptacles has different dimensions. Accordingly, the support members 38 are sizeable to fit within substantially any given air filter receptacle 30. As used herein, the term ‘sizeable’ will be understood to mean that the size or dimensions of the chassis structure 34, i.e., the length of support members 38, can be altered from their original dimensions/lengths to desired or predetermined dimensions/lengths to fit within substantially any given air filter receptacle 30. For example, in another form of the disclosure, distal end portions 39 of each support member 38 include a plurality of break lines 46 that allow a selectable length of each distal end portion 39 to be bent and broken off. Thus, the length of each support member 38 can be adapted to fit within the perimeter dimension of the respective air filter receptacle 30. Alternatively, in various other embodiments, the support members 38 can be fabricated to allow the distal end portions 39 to cut off to a desired length using scissors or metal snips. Or, in yet other embodiments, the distal end portions 39 can include screw or ratchet-tooth adjusters that allow the distal ends 39 to be extended or retracted to fit within the respective air filter receptacle 30. Or, in still other embodiments, the support members 38 can be adjustably telescoping so that the distal end portions 39 can be extended or retracted to fit within the respective air filter receptacle 30. Still further yet, in various implementations, the distal ends 39 of support members 38 can include spring-loaded extenders that allow the distal end portions 39 to be compressed, or retracted, to fit within the respective air filter receptacle 30. Accordingly, the humidifier system 14 is retrofittable such that it can be installed within pre-existing structure, e.g., the air filter receptacle 30, of a furnace system 10.

The humidifier system 14 additionally includes a porous water retention panel 42 that mounts to the chassis structure 34 using any suitable mounting means, e.g., fasteners, clamps, screws, glue, tie wraps, hook and loop material, etc. The water retention panel 42 is sized to fit within generally all air filter receptacles. As used herein, the term ‘sized’ will be understood to mean that the size or dimensions of the retention panel 42 is/are generally fixed such that the retention panel 42 will fit within substantially any given air filter receptacle 30. The water retention panel 42 is fabricated or structured to temporarily retain water such that air flowing through the wet retention panel 42, from the air supply duct 18 to the furnace box 22, will pick up, or absorb, moisture from the retained water to increase the humidity level, or water concentration, of the air flowing into the furnace box. More specifically, retention panel 42 is fabricated or structured such that water introduced into a top portion 43 of the retention panel will flow through the retention panel 42 at a slow, retarded, or impeded, rate to allow the air flowing through the retention panel 42 to absorb moisture. For example, in various embodiments, the retention panel includes a porous, water absorbing media that absorbs water introduced into the top portion and allows the water to very slowly flow down through the media to a bottom portion 45 of the retention panel 42.

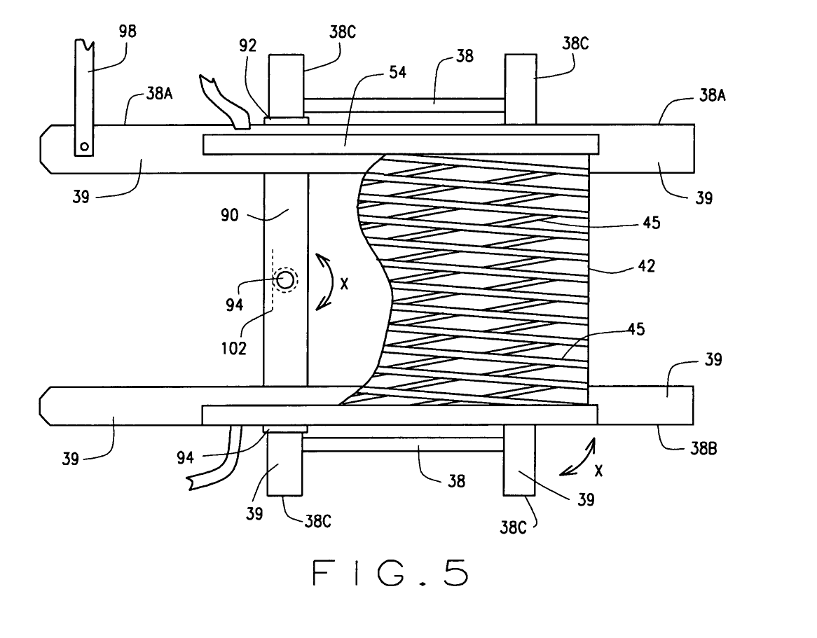

Additionally, the media is porous such that the air from the air supply duct 18 can pass, or flow, through the media to absorb water, thereby increasing the humidity level of the air entering the furnace box 22 and subsequently, the air forced through the forced air duct 22 into the enclosed environment. In other forms of the present disclosure, the retention panel 42 can include a porous non-water-absorbing, water retaining media, such as metal or glass fibers, that collect water on the surfaces of fibers, but severely impedes the flow of water through the retention panel 42. Thus, the air flowing through the media can absorb the water from the surfaces or the fibers, thereby increasing the humidity level of the air ultimately provided to the enclosed environment. In yet other embodiments, the retention panel can include a network of porous tubes or channels 45, shown in FIG. 5, that are adapted to allow the water introduced into the top portion 43 of the retention panel 42 to flow through the tubes or channels. Thus, the air flowing across the tubes or channel can absorb the water from within the tubes or channels, thereby increasing the humidity level of the air ultimately provided to the enclosed environment.

To provide water to a top portion 43 of the retention panel, the humidifier system includes a water supply and drain system 50 that forms at least a portion of the chassis structure 34. Particularly, the supply and drain system 50 provides water to, and channels water away from, the water retention panel 42. The plurality of support members 38 that comprise the chassis structure 34 include an upper horizontal member 38A and a lower horizontal member 38B. Although the upper and lower members 38A and 38B are described as horizontal, the upper and lower members 38A and 38B can have a slight cant such that they are slightly off-horizontal to aid in providing water to, and channeling water away, from the retention panel 42, as described below. The upper horizontal member 38A is mounted to the top portion 43 of the retention panel 42 and the lower horizontal member 38B is mounted to the bottom portion 45 of the retention panel 42. The upper and lower horizontal members 38A and 38B are connected to at least one vertical member 38C. Although the chassis structure 34 is illustrated throughout the figures as including a pair of vertical members 38C, it should be understood that the chassis structure 34 can include one, two, or more vertical members 38C and remain within the scope of the present disclosure.

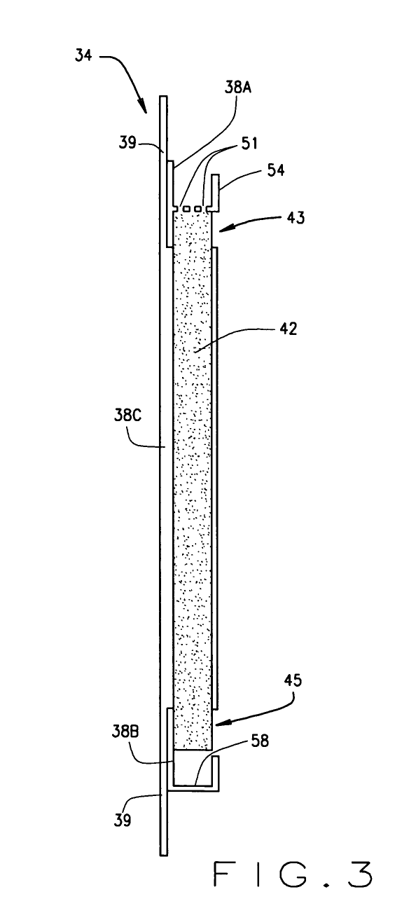

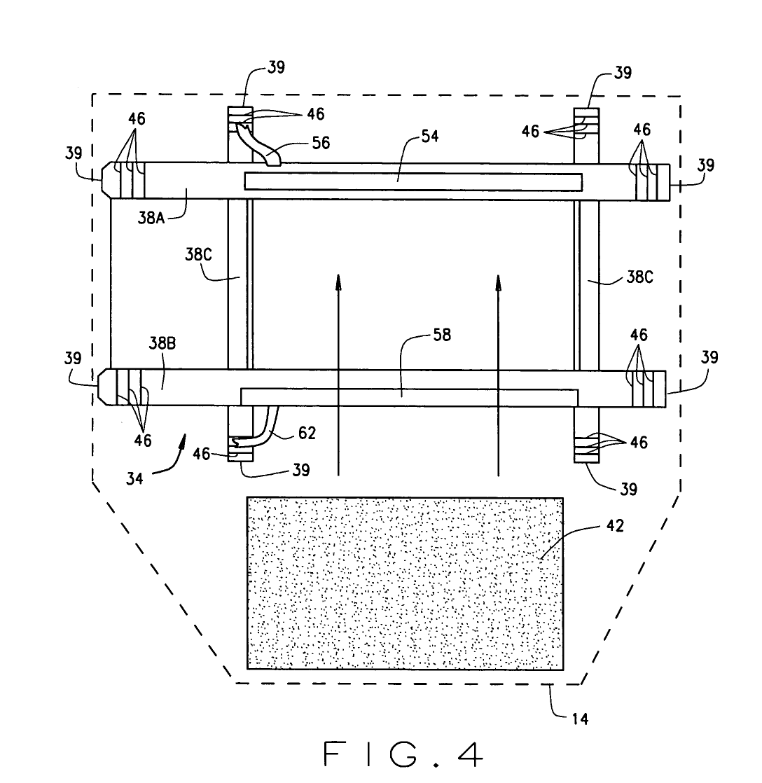

As best illustrated in FIGS. 3 and 4, the upper horizontal support member 38A includes an upper conduit 54, e.g., a channel or tube, of the water supply and drain system 50. The upper conduit 54 is structured to receive water from an inlet hose 56 connected to a water supply (not shown) and to have a porous bottom including a plurality of holes 51. Thus, the upper conduit 54 receives water from the water supply, via the inlet hose 56, and channels the water to the top portion 43 of the retention panel 42 through the holes 51. Accordingly, the water drips, or flows, through the porous bottom of the upper conduit 54, i.e., through the holes 51, to wet and flow through the retention panel 42 to the bottom portion 45 of the retention panel 42, as described above. Additionally, the lower horizontal support member 38B includes a lower channel 58 of the water supply and drain system 50. The lower channel 58 is structured to receive excess water from the bottom portion 45 of the retention panel 42 that has flowed through the retention panel 42, as described above. The lower channel 58 collects the excess water and channels the water away through a drain hose 62 to a drain (not shown).

Referring particularly to FIG. 2, in various embodiments the water supply and drain system 50 includes a water flow regulator 66 that regulates, controls, or meters the flow of water dispensed to the upper conduit 54. The water flow regulator 66 is connected to the water supply via a supply hose 70 and also to the inlet hose 56. The water supply can be any suitable water supply such as a constant, main water supply of the enclosed environment or a water reservoir located near the water flow regulator 66. The water flow regulator 66 can be any water flow regulator suitable for regulating, controlling or metering the flow of water to the upper conduit 54 such that a desired amount of water is introduced to the top portion 43 of the retention panel 42. For example, the water flow regulator 66 can be a simple continuous flow valve or an electronically controlled water valve that regulates the amount of water flowing to the upper conduit 54 based on temporal parameters or based on a humidity reading within the enclosed environment.

In various other implementations, the water flow regulator 66 is adapted to mix and dispense a fragrant substance and/or an anti-mildew substance with the water into the upper conduit 54. The fragrant and anti-mildew substance can be any suitable water soluble substance, such as a liquid, tablet or powder. Adding a fragrant liquid to the water provided to the upper conduit 54 will result in the forced air delivered to the enclosed environment having a fragrance. Adding an anti-mildew liquid can help reduce mildew built-up on the humidifier system 14 and the forced air duct network 26. The water flow regulator 66 can receive the fragrant substance and/or anti-mildew substance in and suitable manner. For example, in various forms of the present disclosure, the water flow regulator 66 includes a reservoir 74 for receiving the fragrant substance and/or anti-mildew substance. Accordingly, the fragrant substance and/or anti-mildew substance will mix or dissolve with the water flowing though the water flow regulator 66. The resulting water and fragrant substance and/or anti-mildew substance solution then flows into the upper conduit 54 and through the retention panel 42, whereby the water and fragrant substance and/or anti-mildew substance solution is absorbed by the air flowing through the retention panel 42 and dispersed into the enclosed environment, as described above.

Referring now to FIGS. 1A through 4, as described above, the chassis structure 34 is structured to be sizable to fit within approximately any size air filter receptacle 30. Similarly, the retention panel has been described to fit within approximately any size air filter receptacle 30. More specifically, the humidifier system 14, comprising the retention panel 42 mounted to the chassis structure 34 is sizable to fit within, and be retained by any size air filter receptacle 30. As illustrated in FIG. 1A, in various embodiments, the retention panel 42 is sized to be smaller than the air passage opening 28. In such embodiments, the humidifier system 14, i.e., the chassis structure 34 and mounted retention panel 42, is structured to fit within the respective air filter receptacle 30 and then to be moved back such that the retention panel 42 is suspended through the air passage opening 28 in the air supply duct 18. Therefore, the humidifier system 14 is positioned such that the air filter receptacle 30 is unobstructed and an air filter (not shown) can be inserted into the air filter receptacle 30 along with, i.e., adjacent, the chassis structure 34 and mounted retention panel 42. More particularly, the size of air passage opening 28 is smaller than the perimeter of the air filter receptacle 30 such that a lip portion 82 of the air supply duct 18 extends around the air passage opening 28 within the perimeter of the air filter receptacle 30. In various embodiments, the plurality of support members 38 are constructed to fit substantially flush against a face of the lip portion 82 of the air supply duct 18. Therefore, the retention panel 42 is suspended within the air passage opening 28 such that an air filter can be installed within the respective air filter receptacle 3o unobstructed by the retention panel 42 and the chassis structure 34. For example, in various implementations, distal end portions 39 of the one or more vertical members 38C are substantially flat, best shown in FIG. 3, to allow the chassis structure 34 to fit substantially flush against the face of the lip portion 82, best shown in FIG. 1A.

Alternatively, in other forms of the present disclosure, the retention panel 42 is sized to be larger than the air passage opening 28 and the humidifier system 14, i.e., the chassis structure 34 and mounted retention panel 42, is structured to fit within and occupy the respective air filter receptacle 30. In such embodiments, the humidifier system 14, i.e., the retention panel 42, is utilized as both a humidifier, to humidify the air dispersed into the enclosed environment, and also filter the air dispersed into the enclosed environment of particulate matter. Furthermore, in various implementations, in addition to the water retention and/or absorption qualities of the water absorbing media of the retention panel 42, the water absorbing media is fabricated to include air filtering characteristics or properties to remove particulate matter flowing through the retention panel 42.

Referring now to FIG. 5, in various embodiments, the chassis structure 34 includes a pivot brace 90 that is pivotable about arrow X such that the water retention panel 42 is pivotable to compensate for variations in water retention. More specifically, the upper horizontal support member 38A is connected to a first end 92 of the pivot brace 90 and the lower horizontal support member 38B is connected to an opposing second end 94 of the pivot brace 90. The pivot brace 90 is pivotally attached to one vertical support member 38C via a pivot connector 94, e.g., a rivet, bolt, or swivel hinge. Therefore, the upper and the lower horizontal support members 38A and 38B, and the water retention panel 42 mounted to the upper and the lower horizontal support members 38A and 38B are pivotal on the vertical support member 38C, as indicated at arrow X. Particularly, the upper and the lower horizontal support members 38A and 38B, and the mounted water retention panel 42 will pivot based on the weight of the water retained in the water retention panel 42. Additionally, the chassis structure 34 includes a water flow regulator control arm 98 pivotally connected to the distal end portion 39 of the upper horizontal support member 38A. The control arm 98 is operably connected to the water flow regulator 66 to control operation of the water flow regulator 66 based on the weight of water retained within the retention panel 42. For example, if the water retained in the retention panel 42 is not being absorbed by the air passing through the retention panel 42 at a desired rate, the amount of water retained by the retention panel will increase. As the amount of water retained increases, the weigh of the retention panel 42, i.e., the water retained, also increases. As the weight exceeds a balancing point of the retention panel on the pivot connector 94, the retention panel 42 will begin to pivot downward.

As the retention panel pivots downward, simultaneously, the control arm 98 is pushed upward by the upper horizontal support member 98A. The upward movement of the control arm 98 controls operation of the water flow regulator 66. That is, as the control arm 98 moves up, the upward movement of the control arm 98 controls operation of the water flow regulator 66 such that the water flow regulator 66 is commanded, or operated, to reduce the amount of water dispersed into the upper conduit 54. For example, the upward movement of the control arm 98 can control operation of a mechanical or electrical valve (not shown) within the water flow regulator 66. Accordingly, less water will be allowed to flow through the retention panel 42 and the air flowing through the retention panel 42 will reduce the amount of water retained by the retention panel 42. Specifically, water is provided to the retention panel 42 at a slower rate than the air flowing through the retention panel 42 is absorbing the water retained within the retention panel 42. Therefore, the weight of the water retained by the retention panel 42 will slowly decrease and allow the retention panel 42 to seek a balance by moving upward. This will lower the control arm 98 and command or operate the water flow regulator to increase the amount of water dispersed into the upper conduit 42. In various forms of the present disclosure, the chassis structure 34 can include a biasing device 102, such as a spring, connected to the pivot brace 90 and the respective vertical support member 38C for biasing retention panel 42 to the uppermost position. The biasing device also counter balances the retention panel 42 to control the amount of water allowed to be retained within the retention panel 42 before the retention panel 42 starts to pivot downward and then pivot upward as the water retained evaporates.

The description herein is merely exemplary in nature and, thus, variations that do not depart from the gist of that which is described are intended to be within the scope of the teachings. Such variations are not to be regarded as a departure from the spirit and scope of the teachings of the present disclosure.

What is claimed is:

1. A furnace humidifier system comprising a chassis structure sizable to fit within a pre-existing air filter receptacle of a furnace system, a water retention panel mounted to the chassis structure, and a water supply and drain system operable with at least a portion of the chassis structure, the supply and drain system providing water to and channeling water away from the water retention panel.

2. The system of claim 1, wherein the chassis structure is adapted to fit substantially flush against a face of an air supply duct and suspend the water retention panel within an opening in the face of the air supply duct such that an air filter can be installed within the air filter receptacle unobstructed by the furnace humidifier system.

3. The system of claim 1 wherein, the chassis structure includes a plurality of support members to which the water retention panel is mounted, the support members structured to be sizable such that the chassis structure will fit within any of various air filter receptacles having various different perimeter dimensions.

4. The system of claim 3, wherein distal ends of the support members include a plurality of break lines that allow a selectable length of each distal ends to be bent and broken off to size the chassis structure to fit with a selected one of the various air filter receptacles.

5. The system of claim 1, wherein the chassis structure comprises at least one vertical support member connected to an upper horizontal support member and a lower horizontal support member, the upper horizontal support member mounted to a top portion of the water retention panel, the lower horizontal support member mounted to a bottom portion of the water retention panel, and the at least one vertical member sizable to fit within a vertical dimension of a perimeter of the air filter receptacle and the upper and lower support members sizable to have a selectable length.

6. The system of claim 5, wherein the upper horizontal support member comprises an upper conduit of the water supply and drain system, the upper conduit structured to receive water from a water supply and channel the water to a top portion of the water retention panel.

7. The system of claim 6, wherein the retention panel comprises a network of at least one or porous tubes and channels that are adapted to allow the water introduced into the top portion of the retention panel to flow through the at least one of porous tubes and channels.

8. The system of claim 6, wherein the system further includes a reservoir structured to dispense at least one of a liquid fragrance and an anti-mildew liquid with the water into the upper conduit.

9. The system of claim 6, wherein the system further comprises a water flow regulator adapted to regulate the flow of water dispensed to the upper conduit.

10. The system of claim 9, wherein the water flow regulator comprises a metered water dispensing device connected to a constant water supply.

11. The system of claim 9, wherein the water flow regulator comprises a refillable water reservoir including a metered water dispensing device.

12. The system of claim 9, wherein the chassis structure further comprises a pivot brace having the upper horizontal support member connected to a first end and the lower horizontal support member connected to an opposing second end, the pivot brace pivotally attached to one of the at least one vertical support members such that the upper and the lower horizontal support members and the water retention panel mounted therebetween will pivot on the vertical support member based on the weight of the water retained in the water retention panel to control the amount of water dispensed by the water flow regulator.

13. The system of claim 12, wherein the chassis structure further comprises a biasing device connected to the pivot brace for biasing retention panel to an uppermost position.

14. The system of claim 5, wherein the lower horizontal support member comprises a lower channel of the water supply and drain system, the lower channel structured to receive and channel away water exiting from a bottom portion of the water retention panel.

15. A furnace humidifier system comprising a porous water retention panel mounted to a chassis structure and sized to fit within an air filter receptacle located between a furnace box and an air supply duct, the chassis structure constructed to fit substantially flush against a face of the air supply duct and suspend the water retention panel within an opening in the face of the air supply duct such that an air filter can be installed within the air filter receptacle unobstructed by the water retention panel and the chassis structure.

16. The system of claim 15 wherein, the chassis structure includes a plurality of support members to which the water retention panel is mounted, the support members structured to be sizable such that the chassis structure will fit within any of various air filter receptacles having various different perimeter dimensions.

17. The system of claim 16, wherein distal ends of the support members include a plurality of break lines that allow a selectable length of each distal ends to be bent and broken off to size the chassis structure to fit with a selected one of the various air filter receptacles.

18. The system of claim 15, wherein the chassis structure comprises at least one vertical support member connected to an upper horizontal support member mounted to a top portion of the water retention panel and a lower horizontal support member mounted to a bottom portion of the water retention panel, the at least one vertical member sizable to fit within a vertical dimension of a perimeter of the air filter receptacle and the upper and lower support members sizable to have a selected length.

19. The system of claim 18, wherein the system further comprises a water supply and drain system for providing water to and channeling water away from the water retention panel, wherein
the upper horizontal support member comprises an upper conduit of the water supply and drain system structured to receive water from a water supply and channel the water to a top portion of the water retention panel, and
the lower horizontal support member comprises a lower channel of the water supply and drain system structured to receive and channel away water exiting from a bottom portion of the water retention panel.

20. The system of claim 19, wherein the water flow regulator is further adapted to dispense at least one of a liquid fragrance and a anti-mildew liquid with the water into the upper conduit.

21. The system of claim 19, wherein the system further comprises a water flow regulator adapted to regulate the flow of water dispensed to the upper conduit.

22. The system of claim 21, wherein the water flow regulator comprises a metered water dispensing device connected to a constant water supply.

23. The system of claim 21, wherein the water flow regulator comprises a refillable water reservoir including a metered water dispensing device.

24. The system of claim 21, wherein the chassis structure further comprises a pivot brace having the upper horizontal support member connected to a first end and the lower horizontal support member connected to an opposing second end, the pivot brace pivotally attached to one of the at least one vertical support members such that the upper and the lower horizontal support members and the water retention panel mounted therebetween will pivot on the vertical support member based on the weight of the water retained in the water retention panel to control the amount of water dispensed by the water flow regulator.

25. The system of claim 24, wherein the chassis structure further comprises a biasing device connected to the pivot brace for biasing retention panel to an uppermost position.

26. A furnace humidifier system comprising:
a chassis structure including a plurality of sizable support members such that the chassis structure will fit within any of various air filter receptacles located between a respective furnace box and a respective air supply duct, the various air filter receptacles having various different perimeter dimensions;
a porous water retention panel mounted to the chassis structure and sized to fit within the respective air filter receptacle; and
a water supply and drain system that forms at least a portion of the chassis structure, the supply and drain system for providing water to and channeling water away from the water retention panel, wherein
the plurality of support members are constructed to fit substantially flush against a face of the respective air supply duct and suspend the water retention panel within an opening in the face of the respective air supply duct such that an air filter can be installed within the respective air filter receptacle unobstructed by the water retention panel and the chassis structure.

27. The system of claim 26, wherein distal ends of the support members include a plurality of break lines that allow a selectable length of each distal ends to be bent and broken off to size the chassis structure to fit with a selected one of the various air filter receptacles.

28. The system of claim 26, wherein the plurality of support members comprise at least one vertical support member connected to an upper horizontal support member and a lower horizontal support member, the upper horizontal support member mounted to a top portion of the water retention panel, the lower horizontal support member mounted to a bottom portion of the water retention panel, and the at least one vertical member sizable to fit within a vertical dimension of a perimeter of the air filter receptacle and the upper and lower horizontal support members sizable to have a selected length.

29. The system of claim 28, wherein the upper horizontal support member comprises an upper conduit of the water supply and drain system structured to receive water from a water supply and channel the water to a top portion of the water retention panel, and the lower horizontal support member comprises a lower channel of the water supply and drain system structured to receive and channel away water exiting from a bottom portion of the water retention panel.

30. The system of claim 29, wherein the system further comprises a water flow regulator adapted to regulate the flow of water dispensed from the water supply into the upper conduit.

31. A retrofittable furnace humidifier system comprising a water retention panel mounted to a chassis structure, the chassis structure being sizable to fit within a pre-existing air filter receptacle of a furnace system.

32. The system of claim 31 further comprising a water supply and drain system that is operable with at least a portion of the chassis structure for providing water to and channeling water away from the water retention panel.
